(19) United States
(12) Patent Application Publication
(10) Pub. No.: US 2025/0367605 A1
(43) Pub. Date: Dec. 4, 2025

(54) SALINE WATER TREATMENT PRE-TREATMENT OR TREATMENT SYSTEM

(71) Applicant: Blue Planet Technologies WLL, Al Juffair (BH)

(72) Inventor: Salah ALBURAIDI, Al Juffair (BH)

(21) Appl. No.: 19/108,841

(22) PCT Filed: Sep. 8, 2022
(86) PCT No.: PCT/IB2022/058457

§ 371 Date: Mar. 5, 2025

(30) Foreign Application Priority Data
Sep. 5, 2022 (GB) 2212936.5

(51) Int. Cl. B01D 61/58; B01D 61/00; B01D 61/02; B01D 61/04; C02F 1/44; C02F 101/10

(52) U.S. Cl. CPC B01D 61/58; B01D 61/04; C02F 1/442; C02F 1/445; B01D 61/0021; B01D 61/0022; B01D 61/0271; B01D 2313/083; B01D 2313/18; B01D 2313/243; B01D 2317/022; C02F 2101/101; C02F 2201/005; C02F 2301/043; C02F 2301/066; C02F 2301/08

(57) ABSTRACT

A saline water pre-treatment or treatment system using nanofiltration and hybrid forward osmosis: the system comprising: a feed solution, a pressure pump, a nanofiltration module, and a hybrid forward osmosis module.

### FIELD OF THE DISCLOSURE

The present disclosure relates to systems for saline water treatment using nanofiltration and osmosis.

### BACKGROUND

Due to ongoing population growth, rising living standards and requirements, and the development of industrial and agricultural operations, the need for clean water has been increasing globally at a fast rate. In order to meet the growing demands of fresh water, research has been performed on brackish water and seawater desalination technologies to convert it in to usable forms. Known methods of water treatment and pre-treatment include nanofiltration, NF; thermal desalination; forward osmosis, FO; and reverse osmosis, RO.

Nanofiltration separates divalent ions from feed solutions using a nanofiltration membrane. Small molecules such as water molecules flow through the NF membrane while divalent ions are rejected. NF typically only gives divalent ion rejection of 75-99%, and monovalent ion rejection of 30-50%. As a result, NF alone is insufficient to reduce total dissolved salts levels in saline water to the World Health Organization's permitted limit of 500 ppm.

Forward osmosis, FO, uses the difference in osmotic pressure between two solutions separated by a semipermeable membrane to give the transport of water molecules. The hydraulic pressure applied on both sides of the membrane is equal. Water molecules flow from the less concentrated solution side to the more concentrated solution side until an equilibrium state is reached. FO requires a feed solution and a draw solution.

Reverse osmosis, RO, uses hydraulic pressure to give the transport of water molecules across a semipermeable membrane. The hydraulic pressure applied on feed side only. Thus, water molecules flow from a more concentrated feed side to a lower concentration permeate side.

Osmotic pressure assisted reverse osmosis uses a combination of RO and FO components connected in series. In the RO component the hydraulic pressure of feed solution is higher than the hydraulic pressure of permeate side and the water molecules are transported from the feed side to the permeate side. In the FO component, the hydraulic pressure of both sides is equal and water molecules are transported from the low concentration side to the high concentration side due to the difference in osmotic pressure.

The semipermeable membranes used in osmotic processes are susceptible to scaling and fouling from divalent ions in saline water.

Thermal desalination methods can also be used to treat saline water. Thermal desalination involves evaporating the water of feed solution in order to separate pure water from the salts of the feed solution.

One of the major hurdles for the widespread use of thermal or membrane-based desalination technologies is the comparatively high energy requirements and production costs of the technologies.

Aspects of the present disclosure seek to provide a saline water pre-treatment or treatment system that alleviates these problems with prior known systems. In particular, aspects of the present disclosure seek to provide a saline water pre-treatment or treatment system with improved water recovery yield and/or an improved saline water pre-treatment or treatment system with lower energy requirements.

### SUMMARY

According to a first aspect of the present disclosure, there is provided a saline water pre-treatment or treatment system comprising: an inlet for receiving a feed solution, a pressure pump for delivering the feed solution to a nanofiltration, NF, module, and a hybrid forward osmosis, FO, module; the NF module comprising an inlet for receiving the feed solution from the pressure pump, a NF membrane defining a NF permeate portion and a NF reject portion of the NF module, a first outlet in the NF permeate portion, and a second outlet in the NF reject portion; the hybrid FO module comprising a first and second portion separated by a semipermeable membrane, wherein each portion of the hybrid FO module comprises an inlet and an outlet; wherein the system is configured to separate the feed solution in the NF module into a NF permeate solution with a reduced ion concentration and a NF reject solution with an increased ion concentration, the NF reject leaving the NF module at a higher hydraulic pressure than the NF permeate solution due to the pressure pump and NF membrane; wherein the system is further configured to deliver a first solution to the first portion of the hybrid FO module and to deliver the NF reject solution to the second portion of the hybrid FO module, to facilitate the transport of water molecules across the semipermeable membrane from the second portion to the first portion; and wherein the system is configured to output a FO permeate solution from the first portion of the hybrid FO module and a concentrated FO reject solution from the second portion of the hybrid FO module.

In this way, the hybrid FO module is an integrated RO-FO system. The separation in the hybrid FO module takes place based on the combined effect of the hydraulic pressure and the osmotic pressure. The hybrid FO separation has lower pressure requirements than RO and therefore gives a pre-treatment or treatment system with lower energy requirements.

The introduction of the NF system as a pre-treatment system gives a reduction in the hardness content of the feed under separation. Therefore, the NF permeate solution has a less scaling and fouling effect on the subsequent FO membrane process.

The NF reject solution is reused in the system in order to extract more water from the feed solution, and the system provides a water recovery yield of 80%.

In some embodiments, the NF module can be operated in the low pressure range of 20-40 bar. In this way, the energy requirements of the saline water pre-treatment or treatment system are reduced. In alternative embodiments, the NF module can be operated in the high pressure range of 60-80 bar.

In some embodiments, the first solution delivered to the first portion of the hybrid FO module is the NF permeate solution from the NF module. In this way, the system only requires the input of the feed solution to carry out NF and hybrid FO water recovery. The system does not require the input of a draw solution. The system can be used to obtain a water recovery yield of 80% with a single pressure pump and a single feed solution.

In alternative embodiments, the first solution delivered to the first portion of the hybrid FO module is a second feed solution of saline water. In this way, the system can recover water from both a first and second feed solution of saline water.

In some embodiments, the system further comprises a second NF module located after the hybrid FO module; wherein the second NF module is configured to receive and separate the

FO reject solution into a second NF permeate solution and a second NF reject solution. In this way, more water can be recovered from the FO reject solution and the water recovery yield can be increased to 88.57%.

In some embodiments, the system further comprises a second hybrid FO module configured to receive either the FO reject solution or the second NF reject solution in the first portion of the second hybrid FO module; and wherein the second hybrid FO module is configured to receive a second feed solution in the second portion. In this way, the system can recover more water from the FO reject solution or the second NF reject solution. The water recovery yield of the system can be increased to 94.22%.

In some embodiments, the system comprises a second NF module and a second hybrid FO module. In this way, more water can be recovered from the reject solutions and the water recovery yield of the system can be increased.

In some embodiments, the feed solution comprises at least one selected from the group consisting of: seawater, brackish water, industrial sewage water, domestic sewage water, produced water, and oil field produced water. In this way, water recovery of natural or waste saline water can be obtained.

In some embodiments, the first feed solution and the second feed solution are different. In this way, the system can be used to recover water from two different sources of saline water simultaneously.

In some embodiments, the first feed solution is seawater and the second feed solution is oil field produced water.

In some embodiments, the system further comprises a valve configured to allow the controlled bypass of further separation modules by the permeate solutions. In this way, permeate solutions can be extracted from the system at an earlier stage depending on the requirements of the user. In some embodiments, the system further comprises more than one valve configured to allow the controlled bypass of further separation modules by the permeate solutions. In this way, permeate solutions can be extracted from more than one location during the desalination process depending on the requirement of the user.

In some embodiments, the system further comprises a pre-treatment module configured to process the first or second feed solution. In this way, fouling of the semipermeable hybrid FO module membranes can be reduced and the water recovery yield of the system can be increased.

In some embodiments, the geometric configuration of the NF membrane may be spiral wound, plate and frame (flat sheet), hollow fiber modules, a plurality of stacked or layered sheets, nanofiller incorporated membranes, or nanofibers.

In some embodiments, the NF membrane materials may comprise cellulose ester derivatives, other polyamide type thin film composite membranes, or nanocomposite membranes.

In some embodiments, the molecular weight of the NF membrane may be in the range of 200-500 Da.

In some embodiments, the geometric configuration of the membrane of the hybrid FO module may be spiral wound, plate and frame (flat sheet), hollow fiber modules, a plurality of stacked or layered sheets, nanofillers incorporated membranes, or nanofibers. The membrane of the FO hybrid module may be operated in any suitable configuration such as cross flow, co-current, counter-current, axial or radial configurations.

The present invention can be implemented in various desalination and water treatment industries such as: power generation; oil and gas; textile; food and beverage; chemical;

pharmaceutical; dairy; and biorefinery.

### BRIEF DESCRIPTION OF THE DRAWINGS

The disclosure will be further described with reference to examples depicted in the accompanying figures in which:

FIG. 1 is a diagram showing an embodiment of the present invention;

FIG. 2 is a diagram showing a second embodiment of the present invention;

FIG. 3 is a diagram showing a third embodiment of the present invention;

FIG. 4 is a diagram showing a fourth embodiment of the present invention;

FIG. 5 is a diagram showing a fifth embodiment of the present invention; and

FIG. 6 is a diagram showing a sixth embodiment of the present invention.

### DETAILED DESCRIPTION

The following description presents particular examples and, together with the drawings, serves to explain principles of the disclosure. However, the scope of the invention is not intended to be limited to the precise details of the examples, since variations will be apparent to a skilled person and are deemed to be covered by the description. Terms for components used herein should be given a broad interpretation that also encompasses equivalent functions and features. In some cases, alternative terms for structural features may be provided but such terms are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner.

The description herein refers to examples with particular combinations of features, however, it is envisaged that further combinations and cross-combinations of compatible features between embodiments will be possible. Indeed, isolated features may function independently as an invention from other features and not necessarily require implementation as a complete combination.

The main role of the NF module is to separate the sealant and hardness ions from the feed solution. The hardness ions cannot pass through the NF membrane. The ions such as calcium, Ca²⁺, magnesium, Mg²⁺, sulfates, SO₄²⁻, and bicarbonates, HCO₃⁻, limit the life span or reliability of FO and RO membranes by forming a scaling and fouling layer on the membrane surface. Additionally, NF treatment is effective in reducing the salinity of the feed solution and the pressure requirements in the subsequent steps. The typical operating pressure of NF is about 70-400 psi with a maximum operating pressure of about 600 psi to up to 1200 psi. The maximum pressure drop of NF is 12 psi over an element and 50 psi per housing. The typical operating flux of NF is about 13-34 L/m²h.

The FO system consists of a semipermeable membrane. The FO membrane is specially configured within the membrane module to attain high dispersion of draw solution and feed solution throughout the module to attain high permeate flow. FO membranes are thinner than RO membranes due to the non-pressure requirement of the FO process. Operating pressures of up to 70 bar and salt rejections of >99% are suitable.

In the following description, similar numerals will be used for similar parts of embodiments of the present invention.

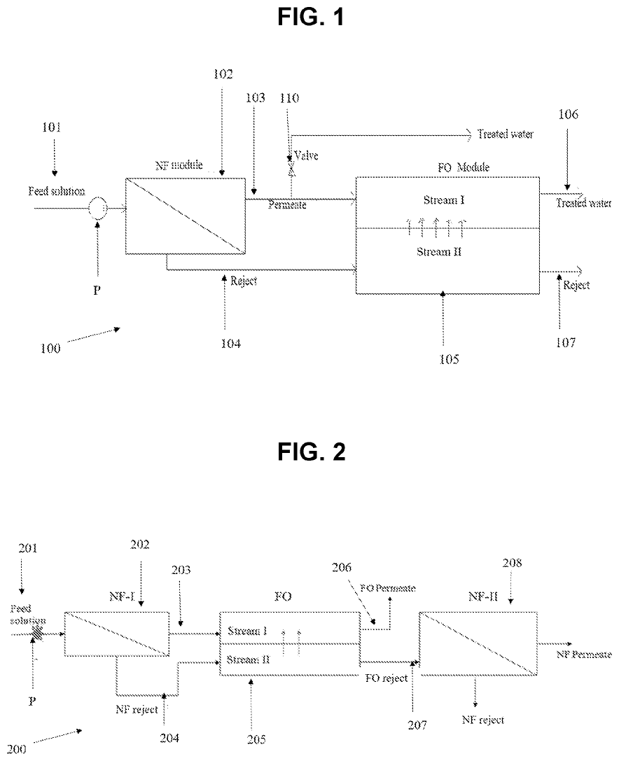

FIG. 1 illustrates a first embodiment of the invention for the pre-treatment of saline water with a yield of up to 80% for direct input into a saline water pre-treatment or treatment system 100 to obtain pure water. The feed solution 101, is inserted into the feed side of the NF module 102 using a pressure pump P. The NF module 102 contains a semipermeable NF membrane. The solution that passes through the semipermeable NF membrane forms the NF permeate 103, which enters Stream I of the FO module 105. The solution that does not pass through the semipermeable NF membrane forms the NF reject solution 104, which enters Stream II of the FO module 105. Within the FO module 105 there will be transport of water molecules from Stream II to Stream I due to the dominated effect of higher hydraulic pressure existing in the Stream II. Therefore Stream Il will be further concentrated and will exit the FO module 105 and the pre-treatment system 100 as a reject solution 107. Whereas, Stream I will be further diluted and leave the FO module 105 and the pre-treatment system 100 system as treated water 106. The system also allows for the NF permeate 103 to be extracted before entering Stream I of the FO module 105 using the valve 110.

FIG. 2 illustrates a system 200 comprising a second NF module 208 after the first NF module 202 and after the FO module 205. A feed solution of saline water 201 enters into the feed side of the NF-I module 202 containing a semi permeable NF membrane using a pressure pump P. The applied pressure at pump P varies in the range of 20-40 bar. The permeate 203 of the NF-I module 202 with the reduced salinity will enter into Stream I of the FO module 205. The NF-I module 202 produces a reject solution 204 that enters into the Stream II side of the FO module 205 at a higher hydraulic pressure in the range of 20-40 bar. Within the FO module 205 there will be transport of water molecules from Stream II to Stream I due to the dominating effect of the higher hydraulic pressure in Stream II. Therefore, Stream I will be further diluted and leave the system 200 as treated water 206 (FO permeate). The concentrated Stream II 207 carrying higher hydraulic pressure (20-40 bar) is fed into the feed side of the NF-II module 208. The NF-II module 8 will produces the second portion of the treated water (NF permeate) to increase the overall water recovery of the pre-treatment system to 85-95%. The NF-II module 208 reject solution exits the system as a concentrated reject solution. Overall, an improved water recovery of 88% was achieved during the seawater pre-treatment experimentation. The process utilizes a single pump and only one feed solution.

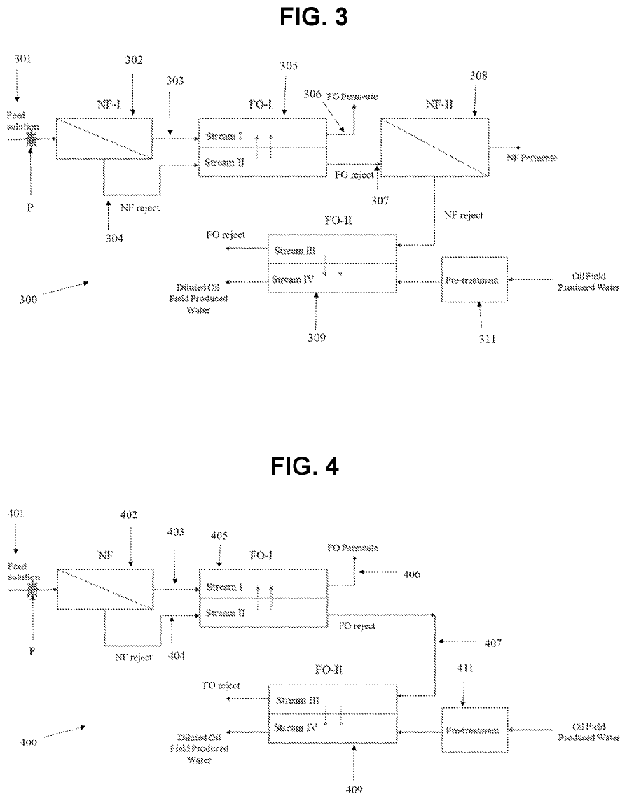

FIG. 3 illustrates a system 300 comprising a second FO module 309 after the second NF module 308. The system 300 integrates the NF system with the FO system for the pre-treatment of saline water with the pre-treatment of high saline oilfield produced water or any other saline water feed solutions. Overall, the water recovery of the process was improved to 93.5%. The system 300 is similar to the system 200 of FIG. 2 with modifications within the system to make the process applicable for the treatment of the oilfield produced water. The reject solution carrying higher hydraulic pressure (20-40 bar) from the NF-II module 308 is fed into the Stream III of the FO-II module 309. Oil field produced water is pre-treated in a pre-treatment module 311. The pre-treated oilfield produced water having high salinity in the range of 150,000 ppm to 250,000 ppm is fed into Stream IV of the FO II module 309. Within the FO II module 309 water molecules are transported from Stream III to Stream IV due to i) higher osmotic pressure of Stream IV compared to Stream III and the dominating effect of the higher hydraulic pressure in Stream III. Thus, the Stream IV (oilfield produced water) will be diluted. Thus, the entire process has dual benefits of treatment of seawater and oilfield produced water.

FIG. 4 illustrates a system 400 of the present invention, which comprises an NF module 402, a first FO module 405, and a second FO module 409. The system 400 provides a water recovery of up to 94.2%. The reject solution of FO-I 407 (from Stream II) carrying higher hydraulic pressure (20-40 bar) is fed into Stream III of the FO-II module 409. Oil field produced water is pre-treated in a pre-treatment module 411. The pre-treated oilfield produced water having high salinity in the range of 150,000 ppm to 250,000 ppm is fed into Stream IV of the FO-II module. Within the FO-II module 409, water molecules are transported from Stream III to Stream IV due to i) higher osmotic pressure of Stream IV compared to Stream III and ii) the dominating effect of the higher hydraulic pressure in Stream III. Thus, the Stream IV (oilfield produced water) is diluted. Thus, the entire process has dual benefits of treatment of seawater and oilfield produced water.

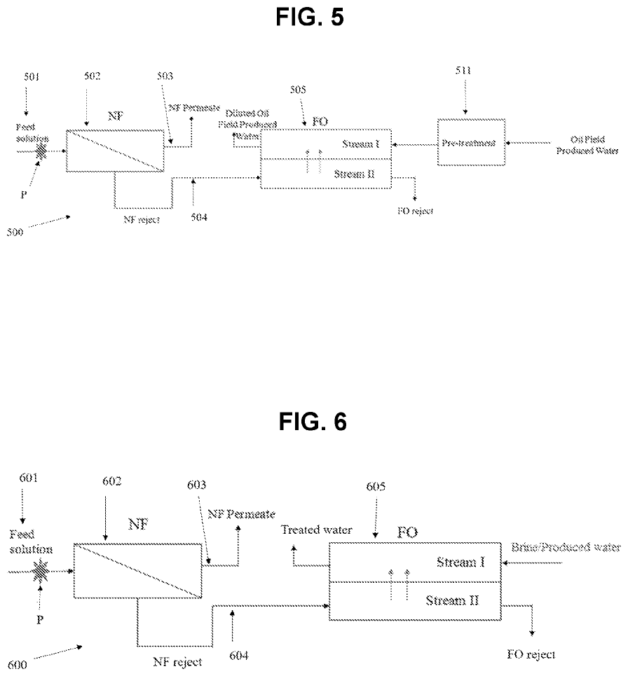

FIG. 5 illustrates a system 500 comprising an NF module 502, an FO-module 505, a saline feed solution and an oil field water produced water feed solution. The system 500 gives a water recovery yield of 85-95%. The feed solution is fed into the feed side of the NF module 502 containing a semi permeable NF membrane using a pressure pump (P). The permeate 503 of the NF module 502 exits the system 500. Oil field produced water is pre-treated in a pre-treatment module 511. The pre-treated oilfield produced water having high salinity in the range of 150,000 ppm to 250,000 ppm is fed into Stream I of the FO module 505. The reject solution 504 of the NF module 502 is fed into Stream Il of the FO module 505 at a higher hydraulic pressure in the range of 20-40 bar. Within the FO module 505 there will be transport of water molecules from Stream II to Stream I due to i) the higher osmotic pressure of Stream I compared to Stream II and ii) the dominating effect of higher hydraulic pressure existing in the Stream II. Thus, the Stream I (oilfield produced water) will be diluted. Thus, the entire process has dual benefits of treating the saline and oilfield produced water in single phase.

FIG. 6 illustrates a system 600 comprising a feed solution, an NF module 602, an FO module 605, and a brine/produced water solution. This system 600 is applicable for the treatment of any high saline wastewater sources such as brine discharge from desalination plants or produced water discharge from the petroleum industry. The feed solution enters into the feed side of the NF module 602 containing a semi permeable NF membrane using a pressure pump P. The applied pressure at pump P may vary in the range of 20-40 bar. The permeate 603 of NF module 602 with the reduced salinity will leave the system as NF permeate. Whereas, the NF reject enters into the Stream II of the FO module 605 at a higher hydraulic pressure. Brine or produced water wastewater discharge having a high salinity is fed into Stream I of the FO module 605. Within the FO module 605 there will be transport of water molecules from Stream II to Stream I due to the dominated effect of higher hydraulic pressure existing in the Stream II. Therefore, Stream I (desalination brine or produced water) will be diluted and leave the system as treated water. Such treated water can be reused in the desalination or petrochemical industry depending on the requirements of the industry. The overall water recovery of the process was improved to 91.43%. The process utilizes a single pressure pump.

The invention is not limited to the specific examples or structures illustrated, a greater number of components than are illustrated in the Figures could be used, for example. There could be an increased number of hybrid FO modules or NF modules. The system could comprise an increased number of feed solutions. The system could also comprise forward or reverse osmosis modules.

1. A saline water pre-treatment or treatment system comprising:
an inlet for receiving a feed solution, a pressure pump for delivering the feed solution to a nanofiltration (NF) module, and a hybrid forward osmosis (FO) module;
the NF module comprising an inlet for receiving the feed solution from the pressure pump, a NF membrane defining a NF permeate portion and a NF reject portion of the NF module, a first outlet in the NF permeate portion, and a second outlet in the NF reject portion;
the hybrid FO module comprising a first and second portion separated by a semipermeable membrane, wherein each portion of the hybrid FO module comprises an inlet and an outlet;
wherein the system is configured to separate the feed solution in the NF module into a NF permeate solution with a reduced ion concentration and a NF reject solution with an increased ion concentration, the NF reject leaving the NF module at a higher hydraulic pressure than the NF permeate solution due to the pressure pump and NF membrane;
wherein the system is further configured to deliver a first solution to the first portion of the hybrid FO module and to deliver the NF reject solution to the second portion of the hybrid FO module, to facilitate the transport of water molecules across the semipermeable membrane from the second portion to the first portion; and
wherein the system is configured to output a FO permeate solution from the first portion of the hybrid FO module and a concentrated FO reject solution from the second portion of the hybrid FO module.

2. The saline water pre-treatment or treatment system of claim 1, wherein the first solution delivered to the first portion of the hybrid FO module is the NF permeate solution from the NF module.

3. The saline water pre-treatment or treatment system of claim 1, wherein the first solution delivered to the first portion of the hybrid FO module is a second feed solution of saline water.

4. The saline water pre-treatment or treatment system of claim 1, wherein the system further comprises a second NF module located after the hybrid FO module; wherein the second NF module is configured to receive and separate the FO reject solution into a second NF permeate solution and a second NF reject solution.

5. The saline water pre-treatment or treatment system of claim 1, wherein the system further comprises a second hybrid FO module configured to receive either the FO reject solution or the second NF reject solution in the first portion of the second hybrid FO module; and wherein the second hybrid FO module is configured to receive a second feed solution in the second portion.

6. The saline water pre-treatment or treatment system of claim 1, wherein the system comprises a second NF module and a second hybrid FO module.

7. The saline water pre-treatment or treatment system of claim 1, wherein the feed solution comprises at least one selected from the group consisting of: seawater, brackish water, industrial sewage water, domestic sewage water, produced water, and oil field produced water.

8. The saline water pre-treatment or treatment system of claim 3 wherein the first feed solution and the second feed solution are different.

9. The saline water pre-treatment or treatment system of claim 1, wherein the system further comprises a valve configured to allow the controlled bypass of further separation modules by the permeate solutions.

10. The saline water pre-treatment or treatment system of claim 1, wherein the system further comprises a pre-treatment module configured to process the first or second feed solution.

11. The saline water pre-treatment or treatment system of claim 5 wherein the first feed solution and the second feed solution are different.
